(19) United States
(12) Patent Application Publication
(10) Pub. No.: US 2017/0249003 A1
(43) Pub. Date: Aug. 31, 2017

(54) PORTABLE TERMINAL

(71) Applicant: KYOCERA CORPORATION, Kyoto (JP)

(72) Inventor: Masatoshi NONOGAKI, Yokohama-shi (JP)

(21) Appl. No.: 15/436,457

(22) Filed: Feb. 17, 2017

(30) Foreign Application Priority Data
Feb. 25, 2016 (JP) 2016-033902

(51) Int. Cl. G06F 1/32; G06F 3/0482; G06F 21/31; G06F 1/16

(52) U.S. Cl. CPC G06F 1/3212; G06F 1/1613; G06F 1/325; G06F 3/0482; G06F 21/31

(57) ABSTRACT

A portable terminal includes a battery, a plurality of apparatuses each of which operates by receiving supply of electric power from the battery, and at least one processor. The at least one processor is configured to cancel locking by using at least one of the plurality of apparatuses. The portable terminal is configured to use a plurality of unlocking schemes different from one another in amount of power consumption for unlocking. The at least one processor is configured to selectively deactivate the plurality of unlocking schemes sequentially from an unlocking scheme greater in amount of power consumption based on a state of charge of the battery.

### CROSS-REFERENCE TO RELATED APPLICATION

The present application claims priority under 35 U.S.C. §119 to Japanese Patent Application No. 2016-033902, filed on Feb. 25, 2016, entitled “Portable Terminal”. The content of which is incorporated by reference herein in its entirety.

### FIELD

The present disclosure relates to a portable terminal with an unlocking function.

### BACKGROUND

A portable terminal with an unlocking function has recently widely been used. The unlocking function is for authenticating a user of a portable terminal by accepting an operation to cancel a locked state of an operation screen and for preventing use of the portable terminal by a third party without permission.

Various techniques for an unlocking scheme have been put into practical use in consideration of operability in unlocking with attention being paid to security strength for prevention of impersonation by a third party. For example, unlocking schemes include face authentication for authentication by shooting a face image of a user, fingerprint authentication for authenticating a fingerprint of a user, voice authentication for authentication by accepting voice input from a user, password authentication for authentication by accepting entry of a password, and pattern authentication for authentication based on a trace of touch operations by a user over a pattern image shown on a screen. The user can normally freely select a desired unlocking scheme from among a plurality of unlocking schemes.

### SUMMARY

A portable terminal according to one embodiment includes an unlocking function to cancel a locked state in which an operation is restricted. The portable terminal includes a battery, a plurality of apparatuses, and at least one processor. Each of the plurality of apparatuses is configured to operate by receiving supply of electric power from the battery. The at least one processor is configured to carry out unlocking by using at least one of the plurality of apparatuses. The portable terminal is configured to use a plurality of unlocking schemes different from one another in amount of power consumption for unlocking. The at least one processor is configured to activate or deactivate each of the plurality of unlocking schemes based on a state of charge of the battery.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a plan view showing one example of appearance of a portable terminal in a first embodiment.

FIG. 2 is a block diagram showing one example of a configuration of the portable terminal.

FIG. 3 is a diagram illustrating an unlocking function of the portable terminal.

FIG. 4 is a diagram showing one example of transition of an operation screen when the unlocking function is activated.

FIG. 5 is a block diagram showing one example of a control configuration of the portable terminal.

FIG. 6 is a diagram illustrating deactivation processing performed by an unlocking scheme setting unit.

FIG. 7 is an example of flowchart illustrating the deactivation processing in the portable terminal.

FIG. 8 is a diagram showing one example of transition of the operation screen when an unlocking scheme is changed.

FIG. 9 is an example of flowchart illustrating unlocking processing in the portable terminal.

FIG. 10 is a diagram showing one example of transition of the operation screen when the portable terminal in a second embodiment automatically changes the unlocking scheme.

FIG. 11 is an example of flowchart illustrating unlocking processing in the portable terminal in the second embodiment.

FIGS. 12 and 13 are diagrams showing other examples of transition of the operation screen when the portable terminal in the second embodiment automatically changes the unlocking scheme.

FIG. 14 is an example of flowchart illustrating deactivation processing in the portable terminal in a third embodiment.

### DETAILED DESCRIPTION

Embodiments will be described below with reference to the drawings.

In general, as security strength is higher, an operation of a device used for authentication of a user is more complicated and hence an unlocking scheme tends to be greater in amount of power consumption for unlocking. Therefore, depending on an unlocking scheme, consumption of electric power in a battery is accelerated each time locking is canceled, and consequently a continuous serviceable time of a portable terminal may disadvantageously become short.

Therefore, an object of the present disclosure is to suppress power consumption for unlocking and increase a continuous serviceable time in a portable terminal with an unlocking function.

### First Embodiment

(Hardware Configuration of Portable Terminal)

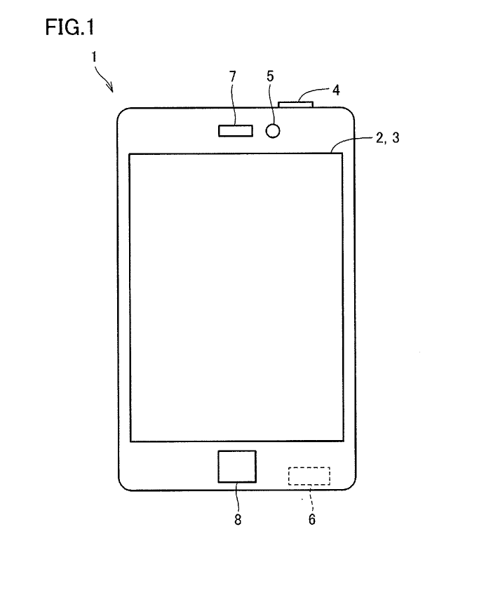

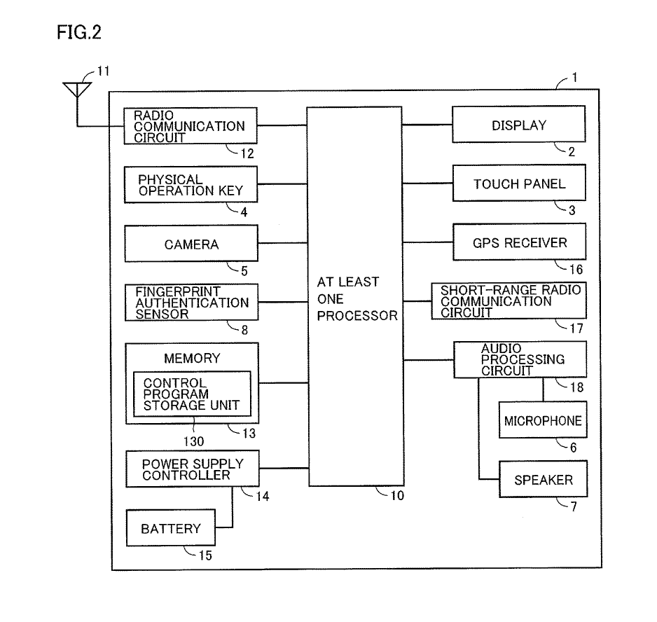

FIG. 1 is a plan view showing one example of appearance of a portable terminal 1 in a first embodiment. FIG. 1 shows a surface of a housing of portable terminal 1 where a display 2 is located. FIG. 2 is a block diagram showing one example of a configuration of portable terminal 1. Though a smartphone is assumed as one embodiment of portable terminal 1 below, a portable terminal such as a portable telephone, a personal digital assistant (PDA), and a tablet PC is also applicable.

Referring to FIGS. 1 and 2, portable terminal 1 includes display 2, a touch panel 3, a physical operation key 4, a camera 5, a microphone 6, a speaker 7, and a fingerprint authentication sensor 8. Portable terminal 1 further includes at least one processor 10, an antenna 11, a radio communication circuit 12, a memory 13, a power supply controller 14, a battery 15, a GPS receiver 16, a short-range radio communication circuit 17, and an audio processing circuit 18. The components are connected to one another through a data bus (not shown).

At least one processor 10 includes, for example, a central processing unit (CPU) and a digital signal processor (DSP). At least one processor 10 can control an operation of portable terminal 1 by reading a control program stored in memory 13 and executing the control program. At least one processor 10 serves as a control unit which comprehensively controls units in portable terminal 1.

At least one processor 10 can provide control and processing capability for performing various functions. In accordance with various embodiments, at least one processor 10 may be implemented as a single integrated circuit (IC) or as multiple communicatively coupled IC's and/or discrete circuits. At least one processor 10 can be implemented in accordance with various known technologies.

In one embodiment, at least one processor 10 includes one or more circuits or units configurable to perform one or more data computing procedures or processes. For example, at least one processor 10 may include one or more processors, controllers, microprocessors, microcontrollers, application specific integrated circuits (ASICs), digital signal processors, programmable logic devices, field programmable gate arrays, or any combination of these devices or structures, or other known devices and structures, to perform the functions described below. A main control configuration of at least one processor 10 will be described later.

Memory 13 includes a control program storage unit 130 configured to store in a non-volatile manner a control program for controlling each unit of portable terminal 1. Memory 13 can store in a volatile manner, data generated as a result of execution of a program by at least one processor 10 or input data.

Display 2 includes, for example, a liquid crystal display (LCD) or an organic electro-luminescence (EL) display.

Touch panel 3 can accept an input operation from a user. Touch panel 3 is, for example, of a capacitance type and can detect a position of touch by a user. Touch panel 3 can output a signal indicating a detected position of touch by a user to at least one processor 10. For example, display 2, touch panel 3, and cover glass can be layered and fitted to the housing of portable terminal 1. Without being limited as such, a display with a touch panel function may be employed, or a touch panel and cover glass as being integrated with each other may be employed.

Physical operation key 4 is a physical input apparatus and can accept a pressing operation by a user. Physical operation key 4 can output a signal indicating operation contents to at least one processor 10 in response to a pressing operation by a user. The number of physical operation keys 4 is not limited to the number shown in FIG. 1 and there may be a plurality of physical operation keys. Arrangement of physical operation key 4 in the housing is not limited as shown in FIG. 1 either, and the physical operation key may be located, for example, on a side surface of the housing.

Camera 5 can shoot a subject. Camera 5 can be used, for example, for shooting a face of a user when the user cancels locking through face authentication.

Microphone 6 can accept voice input and give an audio signal corresponding to the voice input to audio processing circuit 18. Speaker 7 can convert an audio signal given from audio processing circuit 18 to voice and sound and output the voice and sound to the outside of portable terminal 1.

Audio processing circuit 18 can modulate an audio signal given from microphone 6 and output the modulated signal to at least one processor 10. Audio processing circuit 18 can give an audio signal to speaker 7.

Fingerprint authentication sensor 8 is a sensor for recognizing a fingerprint of a user when the user cancels locking through fingerprint authentication. Fingerprint authentication sensor 8 can accept, for example, a pressing operation by a user.

Antenna 11 can radiate a signal generated by portable terminal 1 as radio waves. Antenna 11 can receive radio waves from a space and give a reception signal to radio communication circuit 12.

Radio communication circuit 12 can perform modulation and demodulation processing for transmitting and receiving a signal through antenna 11 for portable terminal 1 to communicate with another radio device. Radio communication circuit 12 can perform modulation and demodulation and frequency conversion of a radio signal transmitted and received by portable terminal 1 and give a reception signal to at least one processor 10.

Battery 15 can supply electric power for operating each unit in portable terminal 1. Battery 15 is a power storage element which can be charged and discharge, and it can be a secondary battery such as a lithium ion battery or a nickel metal hydride battery.

Power supply controller 14 can control supply of electric power from battery 15 to each unit in portable terminal 1. Power supply controller 14 can detect a state of charge of battery 15 based on a voltage, a current, and a temperature of battery 15. Power supply controller 14 can output a signal indicating a detected state of charge of the battery to at least one processor 10.

GPS receiver 16 is a receiver used in a satellite positioning system. The satellite positioning system can receive signals from at least three or four satellites and can detect a current position of portable terminal 1 on which GPS receiver 16 is mounted based on the received signals.

Short-range radio communication circuit 17 can establish short-range radio communication with another apparatus such as a wearable device. A scheme of short-range radio communication includes, for example, Bluetooth®, digital enhanced cordless telecommunication (DECT), dedicated short range communications (DRSC), IBeacon, IrDa, near field communication (NFC), TransferJet, WiMedia Alliance, ZigBee, and Wi-Fi.

(Unlocking Function)

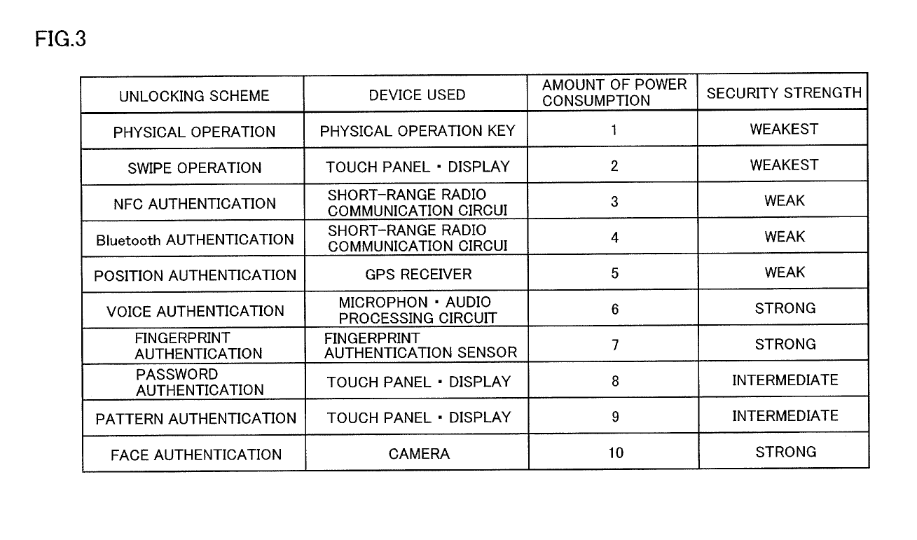

An unlocking function of portable terminal 1 will now be described with reference to FIG. 3.

FIG. 3 shows a plurality of unlocking schemes which can be used by portable terminal 1. Portable terminal 1 can use, for example, ten types of unlocking schemes. These ten types of unlocking schemes are different from one another in amount of power consumption for unlocking.

FIG. 3 shows a device used for unlocking and an amount of power consumption for unlocking for each unlocking scheme. The amount of power consumption is shown in ten levels (levels 1 to 10). FIG. 3 further shows security strength for each unlocking scheme in four levels (weakest, weak, intermediate, and strong). Since an amount of power consumption for each unlocking scheme is generally determined by a device mounted on a portable terminal, the amount of power consumption is not limited to the levels shown in FIG. 3. Since an unlocking scheme which can be used by the portable terminal is dependent on a function of the portable terminal, the unlocking scheme is not limited to the unlocking schemes shown in FIG. 3.

A “physical operation” is a scheme under which locking is canceled in response to acceptance of an operation to press physical operation key 4 while a screen is locked. With the physical operation, when at least one processor 10 accepts a signal from physical operation key 4 while portable terminal 1 is in a low power consumption state (what is called a sleep state), at least one processor 10 can cancel restriction of acceptance of an operation onto portable terminal 1 and cancel locking. When locking is canceled, at least one processor 10 can have display 2 show, for example, a screen which has been operated before transition to a locked state (or a home screen).

“Screen lock” refers to a state that an operation screen is locked, and in this state, acceptance of an operation of portable terminal 1 is restricted. When an operation to cancel the locked state is accepted during screen lock and authentication of a user is successful as a result of this operation, transition to another screen can be made.

A “swipe operation” is a scheme under which locking is canceled in response to acceptance of a swipe operation by touch panel 3 while the screen is locked. The swipe operation refers to such an operation to move a finger in any direction while the finger is in contact with a surface of touch panel 3 and thereafter the finger is moved away from the surface of touch panel 3. The swipe operation includes also a swipe operation to move an object shown on display 2 while a finger touches the object, that is, a drag operation.

When at least one processor 10 accepts a predetermined operation, for example, an operation to switch from off to on of representation on a screen, from a user while portable terminal 1 is in a sleep state, at least one processor 10 can have display 2 show a screen for accepting a swipe operation. When at least one processor 10 accepts a swipe operation, it can cancel locking.

“NFC authentication” is a scheme under which locking is canceled when an NFC tag designated by a user as a reliable device is proximate to portable terminal 1 and communication therewith can be enabled (typically, a distance therebetween is not greater than ten and several centimeters). In NFC authentication, short-range radio communication circuit 17 can output to at least one processor 10, a signal indicating that communication with an NFC tag which is a reliable device can be enabled. When at least one processor 10 accepts the signal from short-range radio communication circuit 17, it can cancel locking.

“Bluetooth authentication” is a scheme under which locking is canceled when a Bluetooth device designated by a user as a reliable device is proximate to portable terminal 1 and communication therewith can be enabled. In Bluetooth authentication, as in NFC authentication, when at least one processor 10 accepts from short-range radio communication circuit 17, a signal indicating that communication with a Bluetooth device can be enabled, it can cancel locking.

“Position authentication” is a scheme under which locking is canceled when portable terminal 1 is located at a place designated by a user as a reliable place. In position authentication, when a current position of portable terminal 1 detected by GPS receiver 16 is determined as matching with the reliable place, at least one processor 10 can cancel locking.

“Voice authentication” is a scheme under which locking is canceled when voice input accepted through microphone 6 while the screen is locked matches with voice of a user registered in advance by the user. In voice authentication, while the screen is locked, audio processing circuit 18 can output an audio signal given from microphone 6 to at least one processor 10. At least one processor 10 can determine whether or not an audio signal from audio processing circuit 18 matches with registered voice stored in memory 13. When the voices match with each other, at least one processor 10 can cancel locking as it determines that an authorized user has performed an unlocking operation.

“Fingerprint authentication” is a scheme under which a user's fingerprint is read by fingerprint authentication sensor 8 while the screen is locked and locking is canceled when the read fingerprint matches with a user's fingerprint registered in advance by the user. In fingerprint authentication, when fingerprint authentication sensor 8 accepts a pressing operation by a user while the screen is locked, it can detect a fingerprint of the user. At least one processor 10 can determine whether or not the fingerprint detected by fingerprint authentication sensor 8 matches with the registered fingerprint stored in memory 13. When these fingerprints match with each other, at least one processor 10 can cancel locking as it determines that an authorized user has performed an unlocking operation.

“Password authentication” is a scheme under which locking is canceled when a password accepted by portable terminal 1 while the screen is locked matches with a password for unlocking registered in advance by a user. A password can include, for example, a PIN code consisting of a four-digit number (or a number of at least four digits) and a password which is a combination of a plurality of characters and numbers.

In password authentication, when a predetermined operation is accepted while portable terminal 1 is in the sleep state, at least one processor 10 can have display 2 show a screen for accepting a password. When at least one processor 10 accepts entry of a password, it can determine whether or not the accepted password matches with a registered password stored in memory 13. When these passwords match with each other, at least one processor 10 can cancel locking as it determines that an authorized user has performed an unlocking operation.

“Pattern authentication” is a scheme under which locking is canceled when a trace of a pattern image shown on display 2 while the screen is locked matches with a trace for unlocking registered in advance by a user. In pattern authentication, when a predetermined operation is accepted while portable terminal 1 is in the sleep state, at least one processor 10 can have display 2 show a pattern authentication screen. When at least one processor 10 detects a trace of operations by a user onto touch panel 3, it can determine whether or not the detected trace of operations matches with the registered trace stored in memory 13. When these traces match with each other, at least one processor 10 can cancel locking as it determines that an authorized user has performed an unlocking operation.

“Face authentication” is a scheme under which locking is canceled when a face image of a user shot by camera 5 while the screen is locked matches with a face image of a user registered in advance by the user. In face authentication, while the screen is locked, camera 5 can shoot a face of a user and output a signal indicating a face image to at least one processor 10. At least one processor 10 can determine whether or not a face image signal from camera 5 matches with a registered face image stored in memory 13. When these face images match with each other, at least one processor 10 can cancel locking as it determines that an authorized user has performed an unlocking operation.

Since the physical operation and the swipe operation do not require user authentication among the ten types of unlocking schemes, they are small in amount of power consumption whereas they are lowest in security strength.

Though NFC authentication, Bluetooth authentication, and position authentication are higher in security strength than the physical operation and the swipe operation, they may be great in amount of power consumption of a device used for detecting a reliable device or place.

Password authentication and pattern authentication can further be higher in security strength than NFC authentication, Bluetooth authentication, and position authentication, whereas they may further be greater in amount of power consumption because a user is authenticated with display 2 and touch panel 3 being operated.

Password authentication and pattern authentication can be greater in amount of power consumption than the swipe operation. This is because, in password authentication and pattern authentication, normally, authentication is carried out as touch panel 3 accepts a swipe operation and thereafter accepts entry of a password or a pattern, and hence one more step for authentication is performed and consequently an amount of power consumption increases. Pattern authentication is greater in amount of power consumption than password authentication because a screen for pattern authentication is greater in display area of display 2 than a screen for entering a password.

Likewise password authentication and pattern authentication, voice authentication, fingerprint authentication, and face authentication are also disadvantageous in being great in amount of power consumption, although they are advantageous in high security strength. This is mainly because of great consumption of electric power for reading information on the registered voice, fingerprint, and face image stored in memory 13. In particular, face authentication is greatest in amount of power consumption because shooting by camera 5 is performed.

Thus, an unlocking scheme high in security strength tends to be greater in amount of power consumption than an unlocking scheme low in security strength. Therefore, since consumption of electric power in the battery is accelerated each time of unlocking of a portable terminal which has been set to be unlocked by using an unlocking scheme high in security strength, a continuous serviceable time of the portable terminal is consequently shorter.

Portable terminal 1 in the first embodiment can selectively deactivate a plurality of unlocking schemes which can be used by portable terminal 1 sequentially from an unlocking scheme greater in amount of power consumption based on a state of charge of the battery. Since the deactivated unlocking scheme can thus no longer be used thereafter, consumption of electric power in battery 15 for unlocking can be suppressed. Therefore, a continuous serviceable time of portable terminal 1 can be longer.

(Setting of Unlocking Function)

In the first embodiment, in a scene where a user activates an unlocking function of portable terminal 1, at least one processor 10 can (1) set an unlocking mode, (2) set an unlocking scheme, and (3) register authentication information, based on an operation by a user.

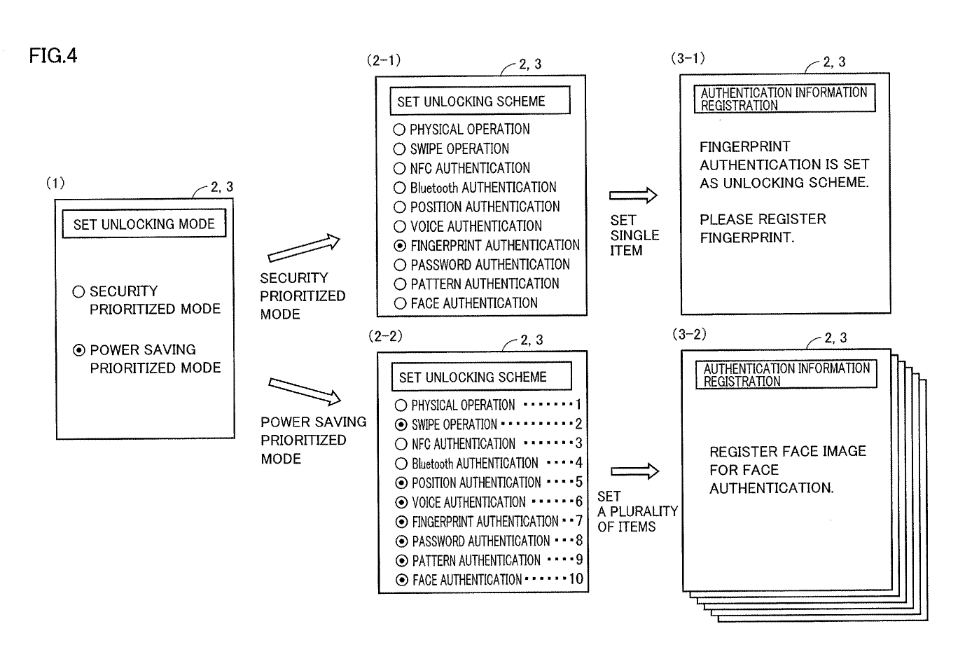

Each processing of (1) to (3) will be described below with reference to FIG. 4. FIG. 4 shows transition of an operation screen when the processing in (1) to (3) is performed.

(1) Setting of Unlocking Mode

When at least one processor 10 accepts an operation to activate an unlocking function, it can have display 2 show an operation screen for setting an unlocking mode (hereinafter also referred to as an “unlocking mode setting screen”).

FIG. 4(1) shows a representation example of the unlocking mode setting screen. In the first embodiment, the unlocking mode setting screen can accept selection of a “security prioritized mode” and a “power saving prioritized mode” as unlocking modes.

The “security prioritized mode” is a mode for canceling locking by using an unlocking scheme selected by a user among a plurality of unlocking schemes. In the security prioritized mode, regardless of a state of charge of the battery, an unlocking scheme selected by a user can be employed. Therefore, in the security prioritized mode, at least one processor 10 can maintain all unlocking schemes active without selectively deactivating an unlocking scheme. Consequently, when a user selects an unlocking scheme high in security strength, use of the selected unlocking scheme can be continued even though a state of charge of the battery lowers and hence security strength can be maintained. Consumption of electric power in battery 15 can be accelerated.

The “power saving prioritized mode” is a mode for canceling locking with power consumption being restricted as compared with the security prioritized mode. In the power saving prioritized mode, each unlocking scheme can be activated and deactivated based on a state of charge of the battery. For example, when a state of charge of the battery lowers, at least one processor 10 can sequentially deactivate an unlocking scheme greater in amount of power consumption. Therefore, when a state of charge of the battery lowers with an unlocking scheme high in security strength having been selected by a user, the selected unlocking scheme may be deactivated. Therefore, the unlocking scheme should be changed to a scheme smaller in amount of power consumption. In a power saving mode in which consumption of electric power in the portable terminal is suppressed by restricting a communication function or a representation function, the power saving prioritized mode may automatically be set.

Thus, in the power saving prioritized mode, a plurality of unlocking schemes can be used as being switched in accordance with a state of charge of the battery. Then, since an unlocking scheme small in amount of power consumption is used with lowering in state of charge of the battery, an amount of power consumption for unlocking is lowered. Consequently, though security strength may lower, consumption of electric power in battery 15 can be suppressed.

(2) Setting of Unlocking Scheme

When an operation to set an unlocking mode is accepted on the unlocking mode setting screen shown in FIG. 4(1), at least one processor 10 can have display 2 show an operation screen for setting an unlocking scheme to be used for unlocking (hereinafter also referred to as an “unlocking scheme setting screen”).

FIG. 4(2-1) shows a representation example of the unlocking scheme setting screen when portable terminal 1 is set to the security prioritized mode. In the unlocking scheme setting screen, a plurality of unlocking schemes which can be used by portable terminal 1 are shown in a list. In the security prioritized mode, a user can select any one unlocking scheme among the shown plurality of unlocking schemes. The representation example in FIG. 4(2-1) shows that fingerprint authentication has been selected as the unlocking scheme.

FIG. 4(2-2) shows a representation example of the unlocking scheme setting screen when portable terminal 1 is set to the power saving prioritized mode. The unlocking scheme setting screen shows an amount of power consumption in association with each unlocking scheme. An amount of power consumption can be shown, for example, in ten levels. The plurality of unlocking schemes can be shown in a list, for example, in the order of magnitude of an amount of power consumption.

In the power saving prioritized mode, a user can select two or more unlocking schemes among the shown plurality of unlocking schemes. The representation example in FIG. 4(2-2) shows that seven types of unlocking schemes in total of a swipe operation, position authentication, voice authentication, fingerprint authentication, password authentication, pattern authentication, and face authentication are selected as the unlocking schemes.

(3) Registration of Authentication Information

When an operation to set an unlocking scheme is accepted on the unlocking scheme setting screen shown in FIG. 4(2-1) or (2-2), at least one processor 10 can have display 2 show an operation screen for accepting registration of authentication information (hereinafter also referred to as an “authentication information registration screen”).

Authentication information is data used for authenticating a user in an unlocking scheme set by the user. Specifically, authentication information in NFC authentication and Bluetooth authentication is data indicating IDs of an NFC tag and a Bluetooth device which are reliable devices. Authentication information in position authentication is data indicating a position of a reliable place. Authentication information in voice authentication is data representing voice of a user. Authentication information in fingerprint authentication is data representing a fingerprint of a user. Authentication information in password authentication is a password for unlocking and authentication information in pattern authentication is a trace for unlocking. Authentication information in face authentication is data representing a face image of a user.

FIG. 4(3-1) shows a representation example of an authentication information registration screen when fingerprint authentication is set as the unlocking scheme in the security prioritized mode. At least one processor 10 can have display 2 show that fingerprint authentication is set as the unlocking scheme. When a user's fingerprint has not yet been registered, at least one processor 10 can further have display 2 show an authentication information registration screen for accepting registration of a user's fingerprint. When input of a fingerprint is accepted through fingerprint authentication sensor 8, at least one processor 10 can have memory 13 store data representing an accepted fingerprint as authentication information.

Though a user can select any one unlocking scheme among a plurality of unlocking schemes in the security prioritized mode in the example in FIG. 4, the user may be able to select a plurality of unlocking schemes such as face authentication and password authentication. In that case, portable terminal 1 may be configured to be able to simultaneously accept a plurality of selected unlocking schemes and cancel locking when a user is successfully authenticated by using any one unlocking scheme.

FIG. 4(3-2) shows a representation example of the authentication information registration screen when seven types of unlocking schemes in total are set as the unlocking schemes in the power saving prioritized mode. At least one processor 10 can have display 2 show sequentially one by one six authentication registration screens in association with the respective six types of unlocking schemes in total except for a swipe operation. At least one processor 10 can skip representation of an authentication registration screen for an unlocking scheme for which authentication information has been registered. When input of data is accepted through touch panel 3, camera 5, microphone 6, and fingerprint authentication sensor 8, at least one processor 10 can have memory 13 store accepted data as authentication information.

(Control Configuration of Portable Terminal)

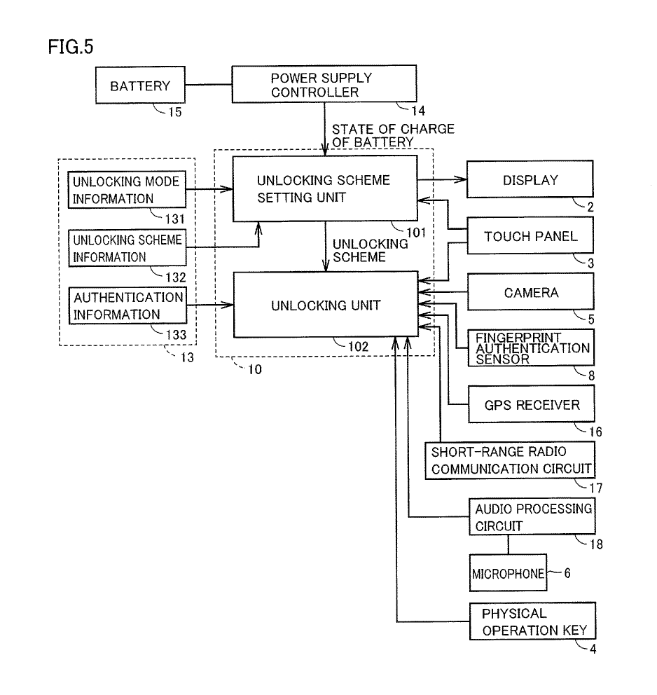

A control configuration for performing unlocking processing will now be described with reference to FIG. 5.

FIG. 5 is a block diagram showing one example of a control configuration of portable terminal 1. Referring to FIG. 5, portable terminal 1 includes power supply controller 14, an unlocking scheme setting unit 101, an unlocking unit 102, and memory 13. The control configuration shown in FIG. 5 can be realized basically as at least one processor 10 of portable terminal 1 executes a control program stored in control program storage unit 130 and gives an instruction to a component of portable terminal 1. At least one processor 10 functions as unlocking scheme setting unit 101 and unlocking unit 102 as it operates in accordance with the control program.

Power supply controller 14 can detect a state of charge of battery 15 and output a signal indicating a detected state of charge of the battery to unlocking scheme setting unit 101.

Memory 13 can store in a non-volatile manner, unlocking mode information 131, unlocking scheme information 132, and authentication information 133. Unlocking mode information 131 includes to which of the security prioritized mode and the power saving prioritized mode portable terminal 1 has been set in (1) setting of an unlocking mode. Unlocking scheme information 132 includes data showing a plurality of unlocking schemes which can be used by portable terminal 1 and data showing an unlocking scheme set in (2) setting of an unlocking scheme. Data showing a plurality of unlocking schemes includes data showing an amount of power consumption and security strength for each unlocking scheme. Authentication information 133 includes data for user authentication for each unlocking scheme registered in (3) registration of authentication information.

When portable terminal 1 accepts a predetermined operation such as an operation to switch from off to on of representation on a screen, unlocking scheme setting unit 101 can set an unlocking scheme to be used for unlocking based on unlocking mode information 131, unlocking scheme information 132, a state of charge of the battery from power supply controller 14, and an operation by a user.

Unlocking unit 102 can cancel locking by using the unlocking scheme set by unlocking scheme setting unit 101.

(Processing for Deactivating Unlocking Scheme)

In the control configuration, when portable terminal 1 is set to the power saving prioritized mode, unlocking scheme setting unit 101 can perform deactivation processing for selectively deactivating a plurality of unlocking schemes based on a state of charge of the battery.

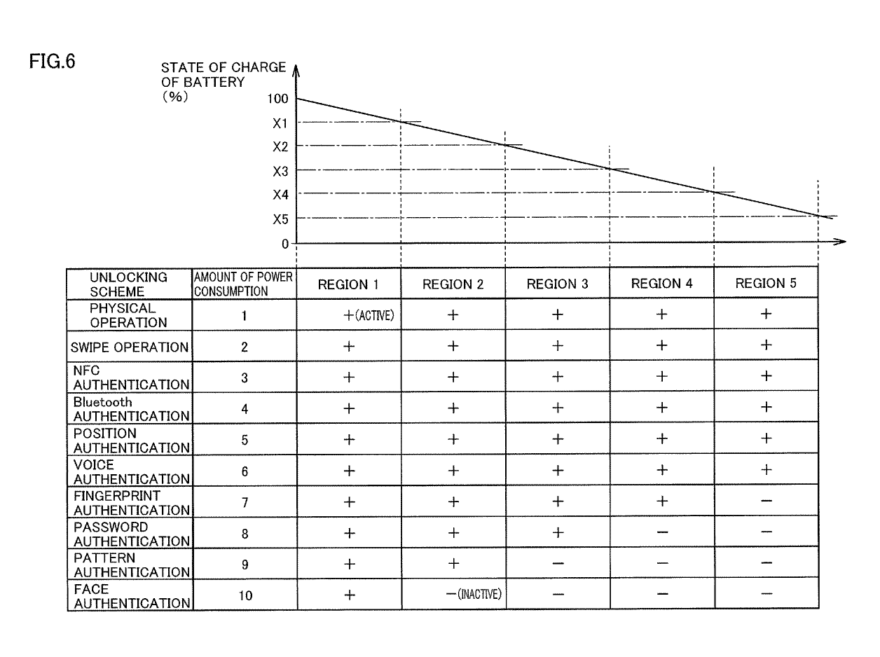

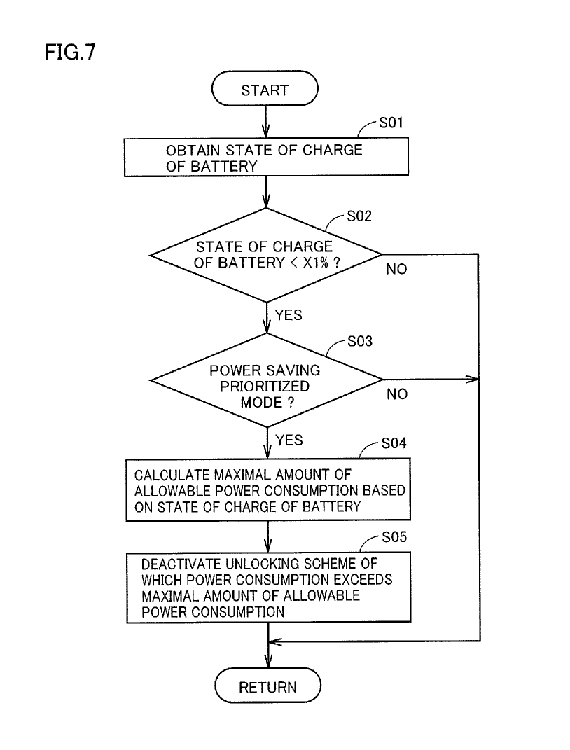

Deactivation processing performed by unlocking scheme setting unit 101 will be described below with reference to FIGS. 6 and 7.

FIG. 6 shows in an upper portion thereof, one example of change over time in state of charge of battery 15. FIG. 6 shows a state of charge of the battery as a ratio (percentage) of a current charging capacity to a full charge capacity of battery 15. FIG. 6 shows lowering in state of charge of the battery from a fully charged state (100%).

FIG. 6 exemplifies in a lower portion thereof, a plurality of unlocking schemes which can be used by portable terminal 1. FIG. 6 shows an amount of power consumption for each of the plurality of unlocking schemes in ten levels and shows whether the unlocking scheme is active or inactive. In FIG. 6, a plus sign + indicates that an unlocking function is active and a minus sign − indicates that an unlocking function is inactive.

When a state of charge of the battery is 100%, all unlocking schemes are active. When a state of charge of the battery lowers from 100% and is lower than X1%, face authentication greatest in amount of power consumption is deactivated. When a state of charge of the battery further lowers from X1% and is lower than X2% (X2<X1), pattern authentication greatest in amount of power consumption next to face authentication is deactivated. In succession, when a state of charge of the battery is lower than X3% (X3<X2), password authentication greatest in amount of power consumption next to pattern authentication is deactivated.

Thus, in a region 1 where a state of charge of the battery is not lower than X1% and not higher than 100%, all unlocking schemes can be used, however, in a region 2 where a state of charge of the battery is not lower than X2% and lower than X1%, face authentication can no longer be used. In a region 3 where a state of charge of the battery is not lower than X3% and lower than X2%, face authentication and pattern authentication can no longer be used. In a region 4 where a state of charge of the battery is not lower than X4% and lower than X3%, face authentication, pattern authentication, and password authentication can no longer be used. In a region 5 where a state of charge of the battery is not lower than X5% and lower than X4%, face authentication, pattern authentication, password authentication, and fingerprint authentication can no longer be used.

Relation between a state of charge of the battery and being active/inactive of an unlocking scheme shown in FIG. 6 can be found based on comparison between a maximal amount of allowable power consumption calculated based on a state of charge of the battery and an amount of power consumption in each locked state scheme. The maximal amount of allowable power consumption refers to a maximal amount of electric power which can be consumed by portable terminal 1 for unlocking. When a state of charge of the battery lowers, the maximal amount of allowable power consumption also lowers. Unlocking scheme setting unit 101 can deactivate an unlocking scheme of which amount of power consumption exceeds the maximal amount of allowable power consumption among the plurality of unlocking schemes. Consequently, as shown in FIG. 6, an unlocking scheme greater in amount of power consumption is sequentially deactivated.

Unlocking scheme setting unit 101 can include a table showing relation between a state of charge of the battery and being active/inactive of an unlocking scheme shown in FIG. 6. Unlocking scheme setting unit 101 can selectively deactivate an unlocking scheme based on a state of charge of the battery given by power supply controller 14 by referring to the table.

Through the deactivation processing described above, when a state of charge of the battery lowers, a currently used unlocking scheme can no longer be used so that a state that locking has to be canceled by using an unlocking scheme smaller in amount of power consumption can be created. With creation of such a state, locking is canceled as switching to an unlocking scheme smaller in amount of power consumption is made, so that consumption of electric power in battery 15 can be suppressed.

FIG. 7 is an example of flowchart illustrating the deactivation processing in portable terminal 1. The deactivation processing in accordance with the flowchart in FIG. 7 can repeatedly be performed by at least one processor 10 every prescribed cycle.

Referring to FIG. 7, at least one processor 10 can obtain a state of charge of battery 15 from power supply controller 14 in step S01. At least one processor 10 can determine in step S02 whether or not the obtained state of charge of the battery is lower than a threshold value X1%. When the state of charge of the battery is not lower than threshold value X1% (determination as NO in S02), at least one processor 10 can quit the process.

When the state of charge of the battery is lower than threshold value X1% (determination as YES in S02), the process proceeds to step S03 and at least one processor 10 can determine whether or not portable terminal 1 has been set to the power saving prioritized mode. When portable terminal 1 has not been set to the power saving prioritized mode, that is, portable terminal 1 has been set to the security prioritized mode (determination as NO in S03), at least one processor 10 can quit the process.

In contrast, when portable terminal 1 has been set to the power saving prioritized mode (determination as YES in S03), at least one processor 10 can calculate a maximal amount of allowable power consumption based on the obtained state of charge of the battery in step S04. The process proceeds to step S05 and at least one processor 10 can deactivate an unlocking scheme of which power consumption exceeds the maximal amount of allowable power consumption calculated in step S04.

In steps S04 and S05 in FIG. 7, at least one processor 10 can determine an unlocking scheme to be deactivated based on the obtained state of charge of the battery by referring to the table in FIG. 6, instead of calculation of the maximal amount of allowable power consumption.

(Change in Unlocking Scheme)

In the power saving prioritized mode, when a currently used unlocking scheme is deactivated, an unlocking scheme used for unlocking should be changed to a scheme smaller in amount of power consumption. In the first embodiment, unlocking scheme setting unit 101 can change the unlocking scheme based on an operation by a user.

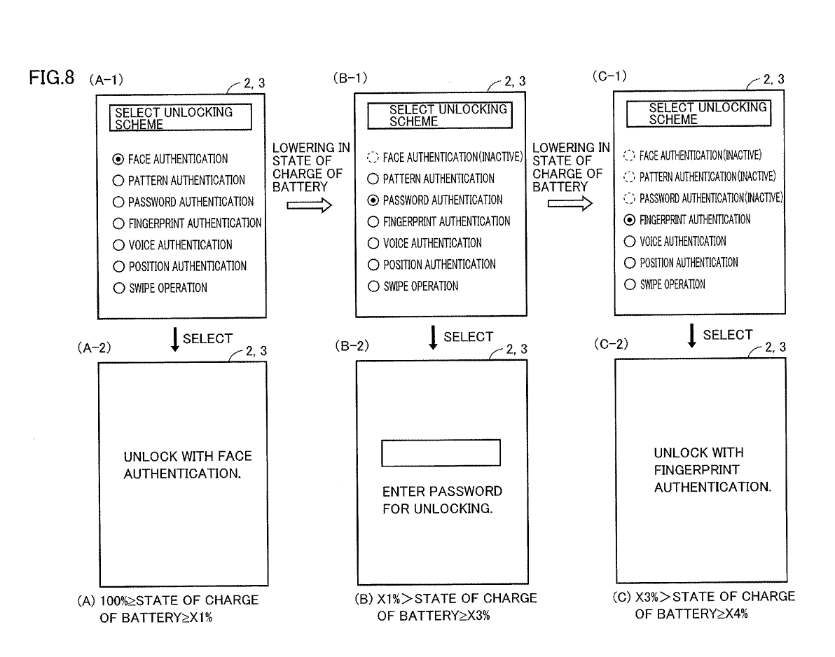

FIG. 8 is a diagram showing one example of transition of an operation screen when the unlocking scheme is changed in accordance with a state of charge of the battery. Transition of the operation screen shown in FIG. 8 is brought in correspondence with the unlocking scheme setting screen shown in FIG. 4(2-2). Seven types of unlocking schemes in total of face authentication, pattern authentication, password authentication, fingerprint authentication, voice authentication, position authentication, and a swipe operation have been set in advance as unlocking schemes to be used in the power saving prioritized mode.

FIG. 8(A) shows one example of the operation screen shown on display 2 when a state of charge of the battery is not lower than X1% and not higher than 100%. When unlocking scheme setting unit 101 accepts a predetermined operation from a user while portable terminal 1 is in the sleep state, it can have display 2 show an operation screen for selecting an unlocking scheme (hereinafter also referred to as an “unlocking scheme selection screen”).

FIG. 8(A-1) shows a representation example of the unlocking scheme selection screen. In the unlocking scheme selection screen, seven types of unlocking schemes in total are shown in a list. Since a state of charge of the battery belongs to region 1 in the table in FIG. 6, unlocking scheme setting unit 101 can allow all unlocking schemes to be active. Therefore, a user can select any one unlocking scheme among the seven types of unlocking schemes shown in the unlocking scheme selection screen.

When selection of an unlocking scheme is accepted, unlocking scheme setting unit 101 can output a signal indicating the selected unlocking scheme to unlocking unit 102. Unlocking unit 102 can cancel locking by using the selected unlocking scheme. For example, when face authentication is selected on the unlocking scheme selection screen in FIG. 8(A-1), unlocking unit 102 can have display 2 show a screen for accepting a face image as shown in FIG. 8(A-2).

Since face authentication is active while a state of charge of the battery belongs to region 1 in FIG. 6, unlocking unit 102 can cancel locking by using face authentication. Therefore, when unlocking scheme setting unit 101 accepts a predetermined operation from a user, it can have display 2 show a screen for accepting a face image in FIG. 8(A-2) with representation of the unlocking scheme selection screen in FIG. 8(A-1) being skipped.

When a state of charge of the battery lowers and becomes lower than X1%, unlocking scheme setting unit 101 can deactivate face authentication. Since currently used face authentication can thus no longer be used, unlocking scheme setting unit 101 can request a user to change the unlocking scheme. Specifically, when unlocking scheme setting unit 101 accepts a predetermined operation from the user while portable terminal 1 is in the sleep state, it has display 2 show the unlocking scheme selection screen in FIG. 8(B-1).

FIG. 8(B-1) shows one example of the unlocking scheme selection screen shown on display 2 when a state of charge of the battery is lower than X1%. Unlocking scheme setting unit 101 can have an indication that face authentication is inactive shown on the unlocking scheme selection screen. Unlocking scheme setting unit 101 can further reject an operation input from a user for face authentication onto touch panel 3. Thus, a user can no longer select deactivated face authentication. In other words, the user can select any one of remaining six types of unlocking schemes except for face authentication. Thus, unlocking scheme setting unit 101 can change the unlocking scheme to an unlocking scheme smaller in amount of power consumption than face authentication based on an operation by a user.

When selection of an unlocking scheme is accepted in the unlocking scheme selection screen in FIG. 8(B-1), unlocking scheme setting unit 101 can output a signal indicating a newly selected unlocking scheme to unlocking unit 102. Unlocking unit 102 can cancel locking by using the newly selected unlocking scheme. For example, when password authentication is newly selected, unlocking unit 102 can have display 2 show a screen for accepting a password as shown in FIG. 8(B-2).

Since password authentication is active while a state of charge of the battery belongs to region 2 or 3 in FIG. 6, unlocking unit 102 can cancel locking by using password authentication. Therefore, when unlocking scheme setting unit 101 accepts a predetermined operation from a user, it can have display 2 show a screen for accepting a password in FIG. 8(B-2) with representation of the unlocking scheme selection screen in FIG. 8(B-1) being skipped.

When a state of charge of the battery lowers and becomes lower than X3%, unlocking scheme setting unit 101 can deactivate password authentication. Since currently used password authentication can thus no longer be used, unlocking scheme setting unit 101 can request a user to change an unlocking scheme again. Specifically, when unlocking scheme setting unit 101 accepts a predetermined operation from the user while portable terminal 1 is in the sleep state, it can have display 2 show the unlocking scheme selection screen in FIG. 8(C-1).

FIG. 8(C-1) shows one example of the unlocking scheme selection screen shown on display 2 when a state of charge of the battery is lower than X3%. Unlocking scheme setting unit 101 can have an indication that face authentication, pattern authentication, and password authentication are inactive shown on the unlocking scheme selection screen. Unlocking scheme setting unit 101 can further reject an operation input from a user for face authentication, pattern authentication, and password authentication onto touch panel 3. Thus, the user can no longer select deactivated face authentication, pattern authentication, and password authentication. In other words, the user can select any one of remaining four types of unlocking schemes except for face authentication, pattern authentication, and password authentication. Thus, unlocking scheme setting unit 101 can change the unlocking scheme to an unlocking scheme smaller in amount of power consumption than password authentication based on an operation by the user.

When selection of the unlocking scheme is accepted in the unlocking scheme selection screen in FIG. 8(C-1), unlocking scheme setting unit 101 can output a signal indicating a newly selected unlocking scheme to unlocking unit 102. Unlocking unit 102 can cancel locking by using the newly selected unlocking scheme. For example, when fingerprint authentication is newly selected, unlocking unit 102 can have display 2 show a screen for accepting a fingerprint as shown in FIG. 8(C-2).

Since fingerprint authentication is active while a state of charge of the battery belongs to region 4 in FIG. 6, unlocking unit 102 can cancel locking by using fingerprint authentication. Therefore, when unlocking scheme setting unit 101 accepts a predetermined operation from a user, it can have display 2 show a screen for accepting a fingerprint in FIG. 8(C-2) with representation of the unlocking scheme selection screen in FIG. 8(C-1) being skipped.

(Unlocking Processing)

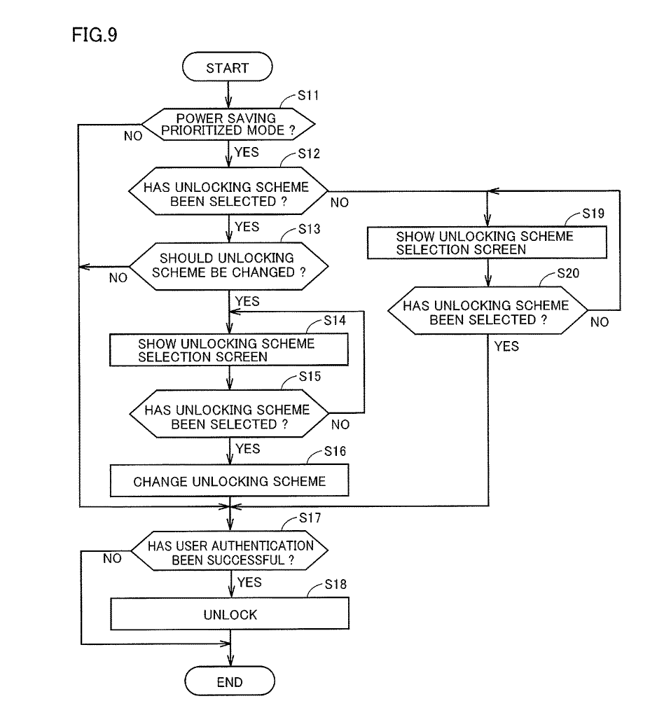

FIG. 9 is a an example of flowchart illustrating unlocking processing in portable terminal 1. Unlocking processing in accordance with the flowchart in FIG. 9 can be performed by at least one processor 10 as portable terminal 1 accepts a predetermined operation such as an operation to switch from off to on of representation of a screen.

Referring to FIG. 9, at least one processor 10 initially determines in step S11 whether or not portable terminal 1 has been set to the power saving prioritized mode. When portable terminal 1 has not been set to the power saving prioritized mode, that is, portable terminal 1 has been set to the security prioritized mode (determination as NO in S11), the process proceeds to step S17 and at least one processor 10 can cancel locking by using an unlocking scheme set by the user. When the user is successfully authenticated in step S17 under the unlocking scheme set by the user (determination as YES in S17), at least one processor 10 cancels locking in step S18. When authentication of a user has failed (determination as NO in S17), at least one processor 10 does not cancel locking.

In contrast, when portable terminal 1 has been set to the power saving prioritized mode (determination as YES in S11), the process proceeds to step S12 and at least one processor 10 can determine whether or not an unlocking scheme has been selected. Specifically, at least one processor 10 can determine whether or not selection of an unlocking scheme has been accepted in the unlocking scheme selection screen (see FIG. 8).

When the unlocking scheme has not been selected (determination as NO in S12), at least one processor 10 can have display 2 show the unlocking scheme selection screen in step S19. In step S19, at least one processor 10 can have information indicating a deactivated unlocking scheme shown on the unlocking scheme selection screen and can reject an operation input from a user for the deactivated unlocking scheme.

At least one processor 10 can determine in step S20 whether or not selection of an unlocking scheme has been accepted in the unlocking scheme selection screen. When selection of the unlocking scheme is accepted (determination as YES in S20), the process proceeds to step S17 and at least one processor 10 can cancel locking by using the unlocking scheme selected by the user. When the unlocking scheme has not been selected (determination as NO in S20), at least one processor 10 can return the process to step S19.

When the unlocking scheme has been selected in step S12 (determination as YES in S12), at least one processor 10 can determine in succession in step S13 whether or not change in unlocking scheme is required. Specifically, at least one processor 10 can determine whether or not the currently used unlocking scheme has been deactivated.

When change in unlocking scheme is not required because the currently used unlocking scheme is active (determination as NO in S13), the process proceeds to step S17 and at least one processor 10 can cancel locking by using the selected unlocking mode.

In contrast, when it is determined that change in unlocking scheme is required because the currently used unlocking scheme has been deactivated (determination as YES in S13), at least one processor 10 can have display 2 show the unlocking scheme selection screen (see FIG. 8) in step S14. In step S14, as in step S19, at least one processor 10 can have information indicating a deactivated unlocking scheme shown on the unlocking scheme selection screen and can reject an operation input from a user for the deactivated unlocking scheme.

When the unlocking scheme selection screen is shown in step S14, at least one processor 10 can determine whether or not an unlocking scheme has been selected in step S15. When an unlocking scheme has been selected (determination as YES in S15), at least one processor 10 changes the unlocking scheme used for unlocking to a newly selected unlocking scheme in step S16. At least one processor 10 can cancel locking by using the changed unlocking scheme in step S17. When a user is successfully authenticated in step S17 under the unlocking scheme set by the user (determination as YES in S17), at least one processor 10 cancels locking in step S18. When authentication of the user has failed (determination as NO in S17), at least one processor 10 does not cancel locking. When an unlocking scheme has not been selected in step S15 (determination as NO in S15), at least one processor 10 can return the process to step S14.

As set forth above, portable terminal 1 can activate and deactivate each of the plurality of unlocking schemes which can be used by portable terminal 1 based on a state of charge of the battery. In particular, since a deactivated unlocking scheme can thereafter no longer be used by sequentially selectively deactivating an unlocking scheme greater in amount of power consumption based on a state of charge of the battery, portable terminal 1 can achieve suppressed consumption of electric power in battery 15 for unlocking. Consequently, a continuous serviceable time of portable terminal 1 can be longer.

### Second Embodiment

In a second embodiment, a configuration in which portable terminal 1 automatically changes an unlocking scheme when a currently used unlocking scheme is deactivated will be described. Since a hardware configuration and a control configuration of portable terminal 1 in the second embodiment are the same as in FIGS. 1 and 5, detailed description will not be repeated.

(Change in Unlocking Scheme)

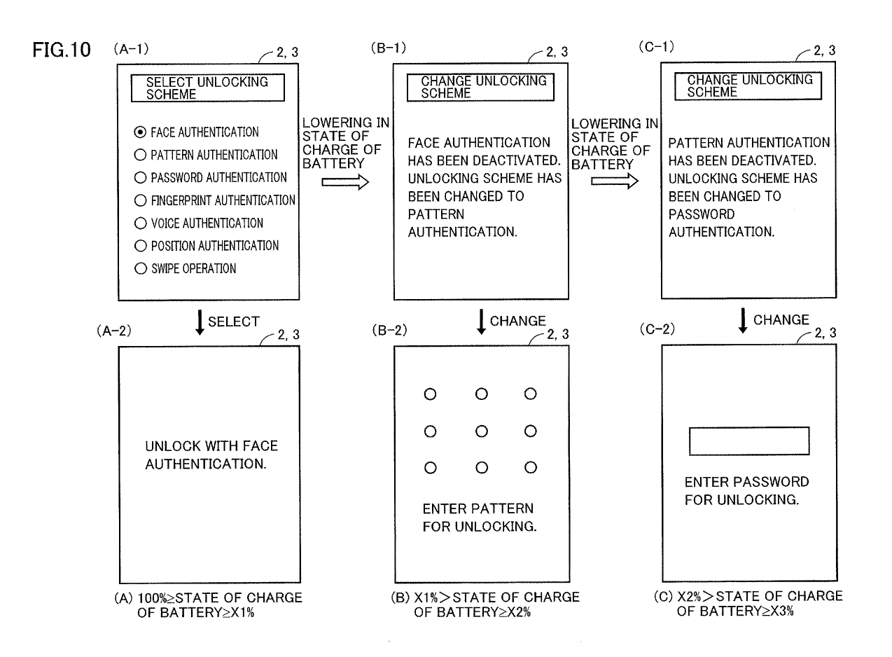

FIG. 10 is a diagram showing one example of transition of an operation screen when portable terminal 1 automatically changes an unlocking scheme. Transition of the operation screen shown in FIG. 10 is brought in correspondence with the unlocking scheme setting screen shown in FIG. 4(2-2). When a user activates an unlocking function, seven types of unlocking schemes in total of face authentication, pattern authentication, password authentication, fingerprint authentication, voice authentication, position authentication, and a swipe operation are set as unlocking schemes to be used in the power saving prioritized mode.

FIG. 10(A) shows one example of the operation screen shown on display 2 when a state of charge of the battery is not lower than X1% and not higher than 100%. When unlocking scheme setting unit 101 (FIG. 5) accepts a predetermined operation from a user while portable terminal 1 is in the sleep state, it can have display 2 show the unlocking scheme selection screen.

FIG. 10(A-1) shows a representation example of the unlocking scheme selection screen. In the unlocking scheme selection screen, seven types of unlocking schemes in total are shown in a list. Since a state of charge of the battery belongs to region 1 in the table in FIG. 6, unlocking scheme setting unit 10 can allow all unlocking schemes to be active. Therefore, a user can select any one unlocking scheme among the seven types of unlocking schemes shown in the unlocking scheme selection screen.

When selection of an unlocking scheme is accepted, unlocking scheme setting unit 101 can output a signal indicating the selected unlocking scheme to unlocking unit 102 (FIG. 5). Unlocking unit 102 can cancel locking by using the selected unlocking scheme. For example, when face authentication is selected on the unlocking scheme selection screen in FIG. 10(A-1), unlocking unit 102 can have display 2 show a screen for accepting a face image as shown in FIG. 10(A-2).

Since face authentication is active while a state of charge of the battery belongs to region 1 in FIG. 6, unlocking unit 102 can cancel locking by using face authentication. Therefore, when unlocking scheme setting unit 101 accepts a predetermined operation from a user, it can have display 2 show a screen for accepting a face image in FIG. 10(A-2) with representation of the unlocking scheme selection screen in FIG. 10(A-1) being skipped.

When a state of charge of the battery lowers and becomes lower than X1%, unlocking scheme setting unit 101 can deactivate face authentication. Since currently used face authentication can thus no longer be used, unlocking scheme setting unit 101 can automatically change the unlocking scheme. Specifically, unlocking scheme setting unit 101 can change to an unlocking scheme greatest in amount of power consumption next to the deactivated unlocking scheme among two or more unlocking schemes set in advance. In the example in FIG. 10, unlocking scheme setting unit 101 can change to pattern authentication greatest in amount of power consumption next to face authentication among six types of unlocking schemes except for face authentication.

When unlocking scheme setting unit 101 accepts a predetermined operation from a user while portable terminal 1 is in the sleep state, it can have display 2 show a screen for notification of change in unlocking scheme (hereinafter also referred to as an “unlocking scheme change screen”).

FIG. 10(B-1) shows one example of the unlocking scheme change screen shown on display 2 when a state of charge of the battery is not lower than X2% and lower than X1%. Unlocking scheme setting unit 101 can have an indication that face authentication is inactive shown on the unlocking scheme change screen. Unlocking scheme setting unit 101 can further have an indication that the unlocking scheme has been changed from face authentication to pattern authentication shown. Thus, unlocking scheme setting unit 101 can change the unlocking scheme to an unlocking scheme smaller in amount of power consumption than face authentication.

When the unlocking scheme is changed to pattern authentication, unlocking scheme setting unit 101 can have display 2 show a pattern authentication screen in FIG. 10(B-2).

Since pattern authentication is active while a state of charge of the battery belongs to region 2 in FIG. 6, unlocking unit 102 can cancel locking by using pattern authentication. Therefore, when unlocking scheme setting unit 101 accepts a predetermined operation from a user, it can have display 2 show the pattern authentication screen in FIG. 10(B-2) with representation of the unlocking scheme change screen in FIG. 10(B-1) being skipped.

When a state of charge of the battery lowers and becomes lower than X2%, unlocking scheme setting unit 101 can deactivate pattern authentication. Since currently used pattern authentication can thus no longer be used, unlocking scheme setting unit 101 can change the unlocking scheme again. Specifically, unlocking scheme setting unit 101 can change to an unlocking scheme greatest in amount of power consumption next to the newly deactivated unlocking scheme among two or more unlocking schemes set in advance. In the example in FIG. 10, unlocking scheme setting unit 101 can change to password authentication greatest in amount of power consumption next to pattern authentication among five types of unlocking schemes except for face authentication and pattern authentication.

When unlocking scheme setting unit 101 accepts a predetermined operation from a user while portable terminal 1 is in the sleep state, it can have display 2 show the unlocking scheme change screen. FIG. 10(C-1) shows one example of the unlocking scheme change screen shown on display 2 when a state of charge of the battery is not lower than X3% and lower than X2%. Unlocking scheme setting unit 101 can have an indication that pattern authentication is inactive shown on the unlocking scheme change screen. Unlocking scheme setting unit 101 can further have an indication that the unlocking scheme has been changed from pattern authentication to password authentication shown. Thus, unlocking scheme setting unit 101 can change the unlocking scheme to an unlocking scheme smaller in amount of power consumption than pattern authentication.

When the unlocking scheme is changed to password authentication, unlocking scheme setting unit 101 can have display 2 show a screen for accepting a password in FIG. 10(C-2). Since password authentication is active while a state of charge of the battery belongs to region 3 in FIG. 6, unlocking unit 102 can cancel locking by using password authentication. Therefore, when unlocking scheme setting unit 101 accepts a predetermined operation from a user, it can have display 2 show the screen for accepting a password in FIG. 10(C-2) with representation of the unlocking scheme change screen in FIG. 10(C-1) being skipped.

(Unlocking Processing)

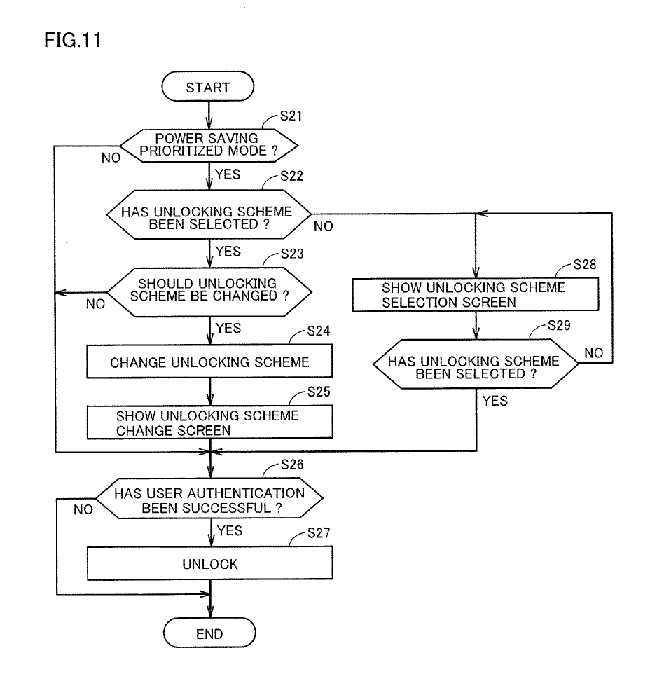

FIG. 11 is an example of flowchart illustrating unlocking processing in portable terminal 1. Unlocking processing in accordance with the flowchart in FIG. 11 can be performed by at least one processor 10 as portable terminal 1 accepts a predetermined operation such as an operation to switch from off to on of representation of a screen.

Referring to FIG. 11, at least one processor 10 initially determines in step S21 whether or not portable terminal 1 has been set to the power saving prioritized mode. When portable terminal 1 has not been set to the power saving prioritized mode, that is, portable terminal 1 has been set to the security prioritized mode (determination as NO in S21), the process proceeds to step S26 and at least one processor 10 can cancel locking by using an unlocking scheme set by the user.

In contrast, when portable terminal 1 has been set to the power saving prioritized mode (determination as YES in S21), the process proceeds to step S22 and at least one processor 10 can determine whether or not an unlocking scheme has been selected. Specifically, at least one processor 10 can determine whether or not selection of an unlocking scheme has been accepted in the unlocking scheme selection screen (see FIG. 10(A-1)).

When the unlocking scheme has not been selected (determination as NO in S22), at least one processor 10 can have display 2 show the unlocking scheme selection screen in step S28. At least one processor 10 can have information indicating a deactivated unlocking scheme shown on the unlocking scheme selection screen. At least one processor 10 can reject an operation input from a user for the deactivated unlocking scheme in the unlocking scheme selection screen.

At least one processor 10 can determine in step S29 whether or not selection of an unlocking scheme has been accepted in the unlocking scheme selection screen. When selection of an unlocking scheme has been accepted (determination as YES in S29), the process proceeds to step S26 and at least one processor 10 can cancel locking by using the unlocking scheme selected by the user. When the user is successfully authenticated in step S26 under the unlocking scheme set by the user (determination as YES in S26), at least one processor 10 cancels locking in step S27. When authentication of the user has failed (determination as NO in S26), at least one processor 10 does not cancel locking. When an unlocking scheme has not been selected in step S29 (determination as NO in S29), at least one processor 10 can return the process to step S28.

When an unlocking scheme has been selected in step S22 (determination as YES in S22), at least one processor 10 can determine in succession in step S23 whether or not change in unlocking scheme is required. Specifically, at least one processor 10 can determine whether or not the currently used unlocking scheme has been deactivated.

When it is determined that change in unlocking scheme is not required because the currently used unlocking scheme is active (determination as NO in S23), the process proceeds to step S26 and at least one processor 10 can cancel locking by using the selected unlocking mode.

In contrast, when it is determined that change in unlocking scheme is required because the currently used unlocking scheme has been deactivated (determination as YES in S23), at least one processor 10 can change the unlocking scheme in step S24. Specifically, at least one processor 10 can change to an unlocking scheme greatest in amount of power consumption next to the deactivated unlocking scheme.

In step S25, at least one processor 10 can have display 2 show the unlocking scheme change screen. At least one processor 10 can have information indicating the deactivated unlocking scheme and the changed unlocking scheme shown on the unlocking scheme change screen.

When the unlocking scheme change screen is shown in step S25, at least one processor 10 can cancel locking by using the changed unlocking scheme in step S26. When the user is successfully authenticated in step S26 under the unlocking scheme set by the user (determination as YES in S26), at least one processor 10 cancels locking in step S27. When authentication of the user has failed (determination as NO in S26), at least one processor 10 does not cancel locking.

As set forth above, when a currently used unlocking scheme is deactivated, portable terminal 1 can automatically change the unlocking scheme used for unlocking to an unlocking scheme greatest in amount of power consumption next to the deactivated unlocking scheme. This is based on the tendency of the unlocking scheme that an amount of power consumption is greater with higher security strength. By changing to an unlocking scheme greatest in amount of power consumption next to the deactivated unlocking scheme, consumption of electric power in battery 15 for unlocking can be suppressed while significant lowering in security strength is suppressed. Therefore, a continuous serviceable time of portable terminal 1 can be longer while lowering in security strength in unlocking is suppressed.

### First Modification of Second Embodiment

Portable terminal 1 in the second embodiment may be changed to an unlocking scheme highest in security strength next to a deactivated unlocking scheme in a scene in which an unlocking scheme is changed.

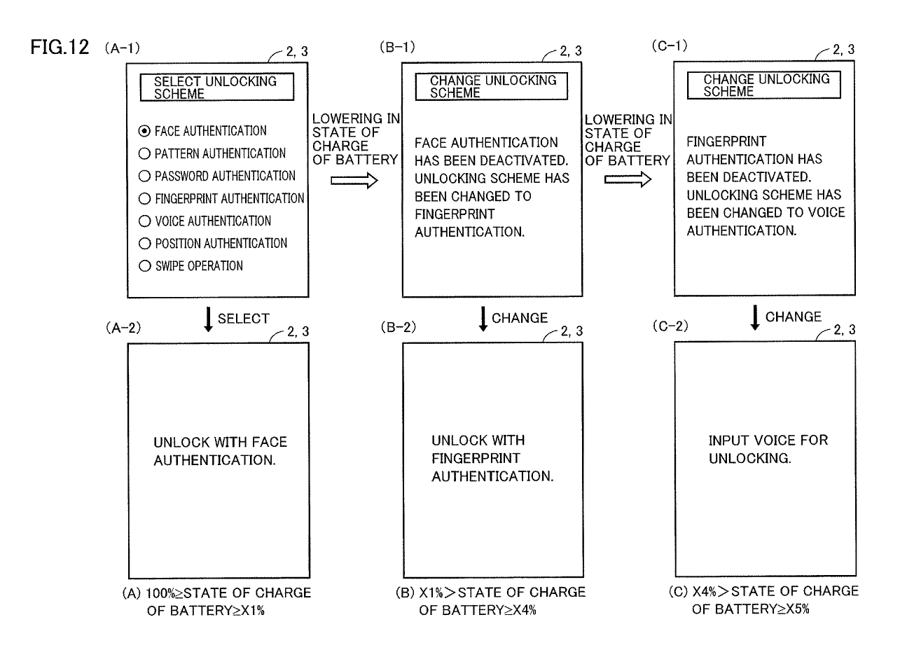

FIG. 12 is a diagram showing another example of transition of the operation screen when at least one processor 10 automatically changes the unlocking scheme. Transition of the operation screen shown in FIG. 12 is brought in correspondence with the unlocking scheme setting screen shown in FIG. 4(2-2). Seven types of unlocking schemes in total of face authentication, pattern authentication, password authentication, fingerprint authentication, voice authentication, position authentication, and a swipe operation have been set in advance as unlocking schemes to be used in the power saving prioritized mode.

FIG. 12(A) shows one example of the operation screen shown on display 2 when a state of charge of the battery is not lower than X1% and not higher than 100%. When unlocking scheme setting unit 101 (FIG. 5) accepts a predetermined operation from a user while portable terminal 1 is in the sleep state, it can have display 2 show the unlocking scheme selection screen.

FIG. 12(A-1) shows a representation example of the unlocking scheme selection screen. FIG. 12(A-2) shows a representation example of the operation screen when face authentication is selected on the unlocking scheme selection screen in FIG. 12(A-1). The operation screens in FIGS. 12(A-1) and (A-2) are the same as the operation screens shown in FIGS. 10(A-1) and (A-2), respectively.

Since face authentication is active while a state of charge of the battery belongs to region 1 in FIG. 6, unlocking unit 102 can cancel locking by using face authentication. Therefore, when unlocking scheme setting unit 101 accepts a predetermined operation from a user, it can have display 2 show a screen for accepting a face image in FIG. 12(A-2) with representation of the unlocking scheme selection screen in FIG. 12(A-1) being skipped.

When a state of charge of the battery lowers and becomes lower than X1%, unlocking scheme setting unit 101 can deactivate face authentication. Since currently used face authentication can thus no longer be used, unlocking scheme setting unit 101 can change the unlocking scheme. Specifically, unlocking scheme setting unit 101 can change to an unlocking scheme highest in security strength next to the deactivated unlocking scheme among two or more unlocking schemes set in advance. In the example in FIG. 12, unlocking scheme setting unit 101 can change to fingerprint authentication highest in security strength next to face authentication among six types of unlocking schemes except for face authentication.

When unlocking scheme setting unit 101 accepts a predetermined operation from a user while portable terminal 1 is in the sleep state, it can have display 2 show the unlocking scheme change screen. FIG. 12(B-1) shows one example of the unlocking scheme change screen shown on display 2 when a state of charge of the battery is not lower than X2% and lower than X1%. Unlocking scheme setting unit 101 can have an indication that face authentication is inactive on the unlocking scheme change screen. Unlocking scheme setting unit 101 can further have an indication that an unlocking scheme to be used for unlocking has been changed from face authentication to fingerprint authentication shown. Thus, unlocking scheme setting unit 101 can automatically change the unlocking scheme to an unlocking scheme smaller in amount of power consumption than face authentication.

When the unlocking scheme is changed to fingerprint authentication, unlocking scheme setting unit 101 can have display 2 show a screen for accepting a fingerprint in FIG. 12(B-2). Since fingerprint authentication is active while a state of charge of the battery belongs to any of regions 2 to 4 in FIG. 6, unlocking unit 102 can cancel locking by using fingerprint authentication. Therefore, when unlocking scheme setting unit 101 accepts a predetermined operation from a user, it can have display 2 show a screen for accepting a fingerprint in FIG. 12(B-2) with representation of the unlocking scheme selection screen in FIG. 12(B-1) being skipped.

When a state of charge of the battery lowers and becomes lower than X4%, unlocking scheme setting unit 101 deactivates fingerprint authentication. Since currently used fingerprint authentication can thus no longer be used, unlocking scheme setting unit 101 can change the unlocking scheme again. Specifically, unlocking scheme setting unit 101 can change to an unlocking scheme highest in security strength next to the newly deactivated unlocking scheme among two or more unlocking schemes set in advance. In the example in FIG. 12, unlocking scheme setting unit 101 can change to voice authentication highest in security strength next to fingerprint authentication among three types of unlocking schemes except for face authentication, pattern authentication, password authentication, and fingerprint authentication.

When unlocking scheme setting unit 101 accepts a predetermined operation from a user while portable terminal 1 is in the sleep state, it can have display 2 show the unlocking scheme change screen. FIG. 12(C-1) shows one example of the unlocking scheme change screen shown on display 2 when a state of charge of the battery is not lower than X5% and lower than X4%. Unlocking scheme setting unit 101 can have an indication that fingerprint authentication is inactive shown on the unlocking scheme change screen. Unlocking scheme setting unit 101 can further have an indication that an unlocking scheme to be used for unlocking has been changed from fingerprint authentication to voice authentication. Thus, unlocking scheme setting unit 101 can automatically change the unlocking scheme to an unlocking scheme smaller in amount of power consumption than fingerprint authentication.

When the unlocking scheme is changed to voice authentication, unlocking scheme setting unit 101 can have display 2 show a screen for accepting voice input in FIG. 12(C-2). Since voice authentication is active while a state of charge of the battery belongs to region 5 in FIG. 6, unlocking unit 102 can cancel locking by using voice authentication. Therefore, when unlocking scheme setting unit 101 accepts a predetermined operation from a user, it can have display 2 show a screen for accepting voice input in FIG. 12(C-2) with representation of the unlocking scheme change screen in FIG. 12(C-1) being skipped.

As set forth above, when a currently used unlocking scheme is deactivated, portable terminal 1 can automatically change the unlocking scheme to be used for unlocking to an unlocking scheme highest in security strength next to the deactivated unlocking scheme. Thus, consumption of electric power in battery 15 for unlocking can be suppressed while significant lowering in security strength is suppressed. Therefore, a continuous serviceable time of portable terminal 1 can be longer while lowering in security strength in unlocking is suppressed.

### Second Modification of Second Embodiment

Portable terminal 1 in the second embodiment may change to an unlocking scheme smallest in amount of power consumption among unlocking schemes except for a deactivated unlocking scheme in a scene in which the unlocking scheme is changed.

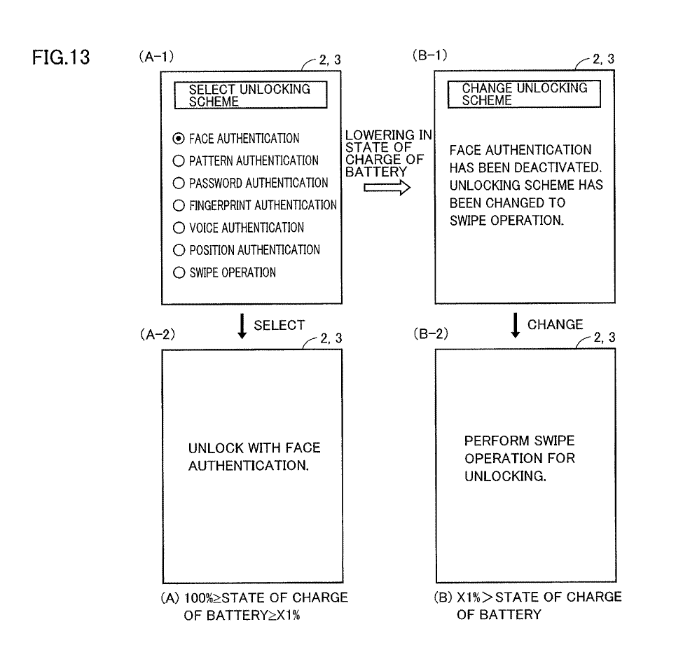

FIG. 13 is a diagram showing another example of transition of the operation screen when at least one processor 10 automatically changes the unlocking scheme. Transition of the operation screen shown in FIG. 13 is brought in correspondence with the unlocking scheme setting screen shown in FIG. 4(2-2). Seven types of unlocking schemes in total of face authentication, pattern authentication, password authentication, fingerprint authentication, voice authentication, position authentication, and a swipe operation are set in advance as unlocking schemes to be used in the power saving prioritized mode.

FIG. 13(A) shows one example of the operation screen shown on display 2 when a state of charge of the battery is not lower than X1% and not higher than 100%. When unlocking scheme setting unit 101 (FIG. 5) accepts a predetermined operation from a user while portable terminal 1 is in the sleep state, it can have display 2 show the unlocking scheme selection screen.

FIG. 13(A-1) shows a representation example of the unlocking scheme selection screen. FIG. 13(A-2) shows a representation example of the operation screen when face authentication is selected on the unlocking scheme selection screen in FIG. 13(A-1). The operation screens in FIGS. 13(A-1) and (A-2) are the same as the operation screens shown in FIGS. 10(A-1) and (A-2), respectively.

Since face authentication is active while a state of charge of the battery belongs to region 1 in FIG. 6, unlocking unit 102 can cancel locking by using face authentication. Therefore, when unlocking scheme setting unit 101 accepts a predetermined operation from a user, it can have display 2 show a screen for accepting a face image in FIG. 13(A-2) with representation of the unlocking scheme selection screen in FIG. 13(A-1) being skipped.

When a state of charge of the battery lowers and becomes lower than X1%, unlocking scheme setting unit 101 can deactivate face authentication. Since currently used face authentication can thus no longer be used, unlocking scheme setting unit 101 can change the unlocking scheme. Specifically, unlocking scheme setting unit 101 can change to an unlocking scheme smallest in amount of power consumption among two or more unlocking schemes set in advance. In the example in FIG. 13, unlocking scheme setting unit 101 can change to the swipe operation smallest in amount of power consumption among six types of unlocking schemes except for face authentication.

When unlocking scheme setting unit 101 accepts a predetermined operation from a user while portable terminal 1 is in the sleep state, it can have display 2 show the unlocking scheme change screen. FIG. 13(B-1) shows one example of the unlocking scheme change screen shown on display 2 when a state of charge of the battery is lower than X1%. Unlocking scheme setting unit 101 can have an indication that face authentication is inactive shown on the unlocking scheme change screen. Unlocking scheme setting unit 101 can further have an indication that the unlocking scheme has been changed from face authentication to the swipe operation shown. Thus, unlocking scheme setting unit 101 can automatically change the unlocking scheme to an unlocking scheme smaller in amount of power consumption than face authentication.

When the unlocking scheme is changed to the swipe operation, unlocking scheme setting unit 101 can have display 2 show a screen for accepting a swipe operation in FIG. 13(B-2). Since the swipe operation is maintained active even when a state of charge of the battery further lowers, unlocking unit 102 can cancel locking by using the swipe operation. Therefore, when unlocking scheme setting unit 101 accepts a predetermined operation from a user, it can have display 2 show a screen for accepting a swipe operation in FIG. 13(B-2) with representation of the unlocking scheme change screen in FIG. 13(B-1) being skipped.

As set forth above, when a currently used unlocking scheme is deactivated, portable terminal 1 can automatically change the unlocking scheme to be used for unlocking to an unlocking scheme smallest in amount of power consumption among remaining unlocking schemes except for the deactivated unlocking scheme. Thus, an effect of suppression of consumption of electric power in battery 15 for unlocking can be increased although security strength is lowered. Therefore, increase in continuous serviceable time of portable terminal 1 can be promoted.

### Third Embodiment

In a third embodiment, a configuration in which while a battery is being charged, an unlocking scheme is not deactivated, that is, all unlocking schemes are active, will be described. Since a hardware configuration and a control configuration of portable terminal 1 in the third embodiment are the same as in FIGS. 1 and 5, detailed description will not be repeated.

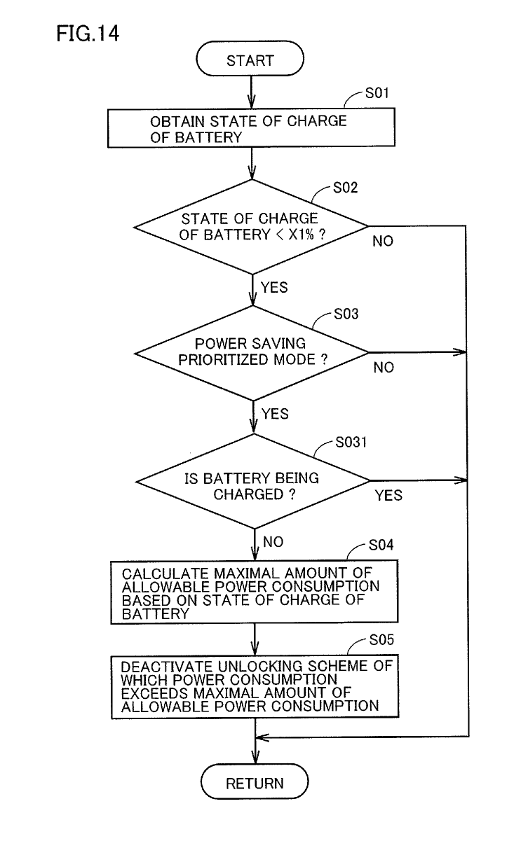

FIG. 14 is an example of flowchart illustrating deactivation processing in portable terminal 1 in the third embodiment. Deactivation processing in accordance with the flowchart in FIG. 14 can repeatedly be performed by at least one processor 10 every prescribed cycle.

Referring to FIG. 14, in steps S01 to S03 as in FIG. 7, when at least one processor 10 obtains a state of charge of battery 15 from power supply controller 14, it can determine whether or not the obtained state of charge of the battery is lower than threshold value X1% and whether or not portable terminal 1 has been set to the power saving prioritized mode.

When the state of charge of the battery is lower than threshold value X1% and when portable terminal 1 has been set to the power saving prioritized mode, the process proceeds to step S031 and at least one processor 10 can determine whether or not battery 15 is being charged. When battery 15 is being charged (determination as YES in S031), at least one processor 10 can quit the process.

In contrast, when battery 15 is not being charged (determination as NO in S031), at least one processor 10 can determine an unlocking scheme to be deactivated based on the obtained state of charge of the battery in steps S04 and S05 as in FIG. 7.

As set forth above, while battery 15 is being charged, portable terminal 1 can allow all unlocking schemes to be active with restriction on power consumption being removed. Thus, even in the power saving prioritized mode, so long as battery 15 is being charged, an unlocking scheme selected by a user can be used as in the security prioritized mode. Therefore, while the battery is being charged, locking can be canceled by using an unlocking scheme high in security strength and hence security strength can be maintained.

Though embodiments of the present disclosure have been described, it should be understood that embodiments disclosed herein are illustrative and non-restrictive in every respect. The scope of the present disclosure is defined by the terms of the claims and is intended to include any modifications within the scope and meaning equivalent to the terms of the claims.

1. A portable terminal with an unlocking function to cancel a locked state in which an operation is restricted, the portable terminal comprising:
a battery;
a plurality of apparatuses each of which operates by receiving electric power from the battery; and
at least one processor configured to carry out unlocking by using at least one of the plurality of apparatuses,
the portable terminal being configured to use a plurality of unlocking schemes different from one another in amount of power consumption for unlocking, and
the at least one processor being configured to activate or deactivate each of the plurality of unlocking schemes based on a state of charge of the battery.

2. The portable terminal according to claim 1, wherein
the at least one processor is configured to selectively deactivate the plurality of unlocking schemes sequentially from the unlocking scheme greater in amount of power consumption based on the state of charge of the battery.

3. The portable terminal according to claim 1, wherein
the plurality of apparatuses include a display, and
the at least one processor is configured to show on the display information showing at least the deactivated unlocking scheme when the at least one processor accepts an operation for unlocking.

4. The portable terminal according to claim 3, wherein
the at least one processor is configured to show on the display a selection screen for having a user select the unlocking scheme other than the deactivated unlocking scheme when the at least one processor accepts the operation for unlocking.

5. The portable terminal according to claim 3, wherein
when unlocking under a first unlocking scheme among the plurality of unlocking schemes is carried out, after the first unlocking scheme is deactivated, the at least one processor is configured to carry out unlocking under a second unlocking scheme smaller in amount of power consumption than the first unlocking scheme.

6. The portable terminal according to claim 5, wherein
the second unlocking scheme is greatest in amount of power consumption next to the first unlocking scheme.

7. The portable terminal according to claim 5, wherein
the second unlocking scheme is highest in security strength among remaining unlocking schemes except for the first unlocking scheme.

8. The portable terminal according to claim 5, wherein
the second unlocking scheme is smallest in amount of power consumption among remaining unlocking schemes except for the first unlocking scheme.

9. The portable terminal according to claim 1, the portable terminal being configured to set which of power saving and security is to be prioritized, wherein
when setting to prioritize the power saving is made, the at least one processor is configured to selectively deactivate the plurality of unlocking schemes sequentially from the unlocking scheme greater in amount of power consumption based on the state of charge of the battery.

10. The portable terminal according to claim 9, wherein
when setting to prioritize the security is made, the at least one processor is configured to carry out unlocking under the unlocking scheme selected by a user.

11. The portable terminal according to claim 1, wherein
while the battery is being charged, the at least one processor is configured to activate all of the plurality of unlocking schemes.
